(19) United States
(12) Patent Application Publication
(10) Pub. No.: US 2013/0061392 A1
(43) Pub. Date: Mar. 14, 2013

(54) Combination Perimeter Element and Support Boom

(71) Applicant: Robert Mark Zerhusen, Cincinnati, OH (US)

(72) Inventor: Robert Mark Zerhusen, Cincinnati, OH (US)

(21) Appl. No.: 13/228,131

(22) Filed: Sep. 8, 2011

(51) Int. Cl. A61G 7/14; A61G 7/10

(52) U.S. Cl. 5/87.1; 5/81.1 R

(57) ABSTRACT

An occupant support (20) comprises a frame (34), a mattress region (58), and a combination perimeter element/boom (80) which comprises a coupling (82) connected or connectable to the frame and to a working element (162). The coupling renders the working element positionable in a perimeter element position where the working element borders the mattress region and functions as a perimeter element and a boom position in which the working element is higher than the mattress and functions as a boom. A combination perimeter element/boom (80) comprises a frame (74), a coupling (82) connected or connectable to the frame and to a working element (162) having length, height and width axes. The coupling renders the working element positionable in a perimeter element position where the length and height axes lie in a vertical plane and in a boom position in which the length and height axes lie in a horizontal plane.

### TECHNICAL FIELD

The subject matter described herein relates to a combination of a perimeter element of the type used on hospital beds and a support boom for supporting a person on a sling. One embodiment is a combination siderail and boom.

### BACKGROUND

Beds of the type used in hospitals, other health care facilities and home care settings typically have a number of perimeter elements such as endboards and siderails. Another item of equipment used in health care settings is a patient sling attached to a mobile lift or to a translatable overhead hoist secured to the structure of the facility. In practice a patient is cradled in the sling and hoisted up, out of a bed or chair, so that he or she can be moved to another location either by rolling the mobile lift or by operating the overhead hoist so that it moves along a track or similar guide.

### SUMMARY

An occupant support comprises a frame, a mattress region, and a combination perimeter element/boom. The combination perimeter element/boom comprises a coupling connected or connectable to the frame and to a working element. The coupling is configured to render the working element positionable in a perimeter element position in which the working element borders the mattress region and functions as a perimeter element and a boom position in which the working element is at an elevation higher than that of the mattress and can function as a boom.

A combination perimeter element/boom comprises a frame, a coupling connected or connectable to the frame and to a working element having mutually orthogonal length, height and width axes. The coupling is configured to render the working element positionable in a perimeter element position in which the length and height axes lie in a vertical plane and in a boom position in which the length and height axes lie in a horizontal plane.

### BRIEF DESCRIPTION OF THE DRAWINGS

The foregoing and other features of the various embodiments of the combination perimeter element and boom described herein will become more apparent from the following detailed description and the accompanying drawings in which:

FIG. 1 is a perspective view of a hospital bed with a combination perimeter element/boom in the form of a siderail/boom and showing a working element of the perimeter element/boom in a siderail position, in particular a deployed siderail position in which the working element of the perimeter element/boom borders the edge of a mattress and lies in a substantially vertical plane.

FIG. 2 is a view similar to that of FIG. 1 showing the perimeter element/boom in a siderail position, in particular a stowed siderail position for accommodating ingress or egress of a bed occupant and in which the perimeter element/boom lies in a nonvertical but nearly vertical plane.

FIG. 3 is a view similar to that of FIGS. 1-2 showing the perimeter element/boom in a boom position in which the working element is at an elevation above the mattress and also showing a patient elevated above the mattress by reason of being cradled in a sling supported from the working element of the perimeter element/boom.

FIG. 4 is a view similar to that of FIG. 3 showing the working element having been rotated about a yaw axis so that the patient is no longer above the mattress.

FIG. 5 is a perspective view similar to that of FIG. 3 with selected elements having been removed or broken away to reveal other features otherwise not readily visible.

FIGS. 6-8 are exploded views showing construction details of the siderail/boom.

FIG. 9 is a view showing outriggers pivotably secured to a frame of the bed for stabilizing the bed.

FIGS. 10A-10B are views showing a counterweight panel for stabilizing the bed.

FIG. 11 is a view showing a hook and D-ring arrangement for stabilizing the bed.

FIG. 12 is a view similar to that of FIG. 1 showing a bed with dual siderail/booms.

FIG. 13 is a view showing a motorized version of the perimeter element/boom.

FIG. 14 is an exploded view depicting the perimeter element/boom as an accessory which is attachable to and detachable from the bed frame and showing the working element of the perimeter element/boom in a boom position.

FIG. 15 is a view similar to that of FIG. 14 showing the perimeter element/boom assembled and showing the perimeter element/boom in a siderail position, in particular in a deployed siderail position.

### DETAILED DESCRIPTION

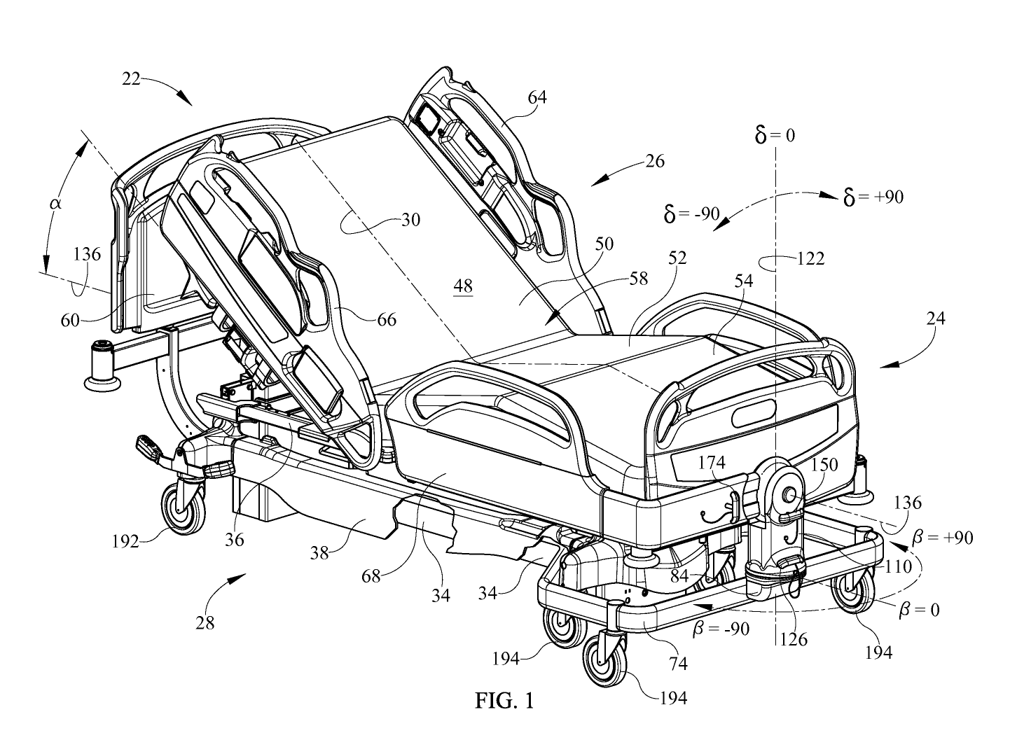

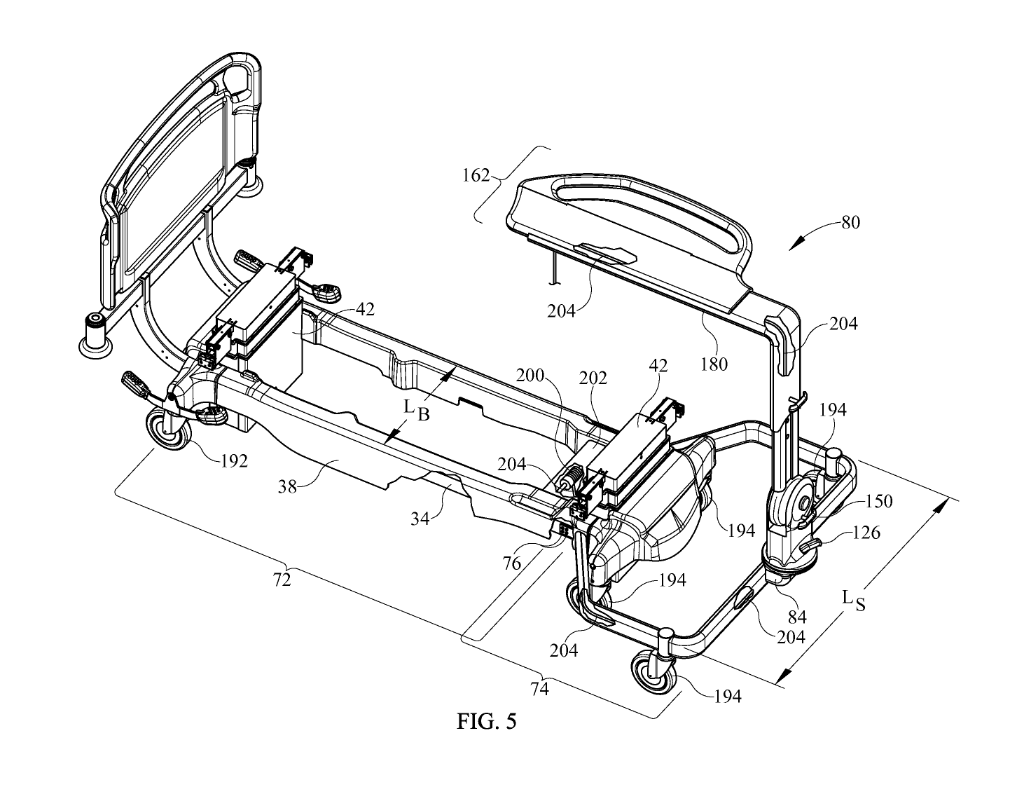

FIGS. 1-5 shows an occupant support 20, specifically a hospital bed. The bed extends longitudinally from a head end 22 to a foot end 24 and laterally from a left side 26 to a right side 28. A longitudinal centerline 30 is illustrated for later reference. The bed includes a framework comprising a base frame 34 and an elevatable frame 36. A shroud 38 covers portions of the base frame. The elevatable frame is connected to the base frame by a lift system, exemplified by canister lifts 42 (FIG. 5), so that the elevatable frame can be raised and lowered relative to the base frame and relative to floor 44. A segmented deck, not visible, is supported on the elevatable frame and, in the context of the present disclosure, may be considered a part of the elevatable frame. The deck is comprised of longitudinally distributed torso, thigh and calf segments, at least some of which are orientation adjustable. A mattress 48 rests on the deck. The mattress has torso, thigh and calf sections 50, 52, 54 corresponding to the torso, thigh and calf segments of the deck. In FIGS. 1-4 the deck torso segment and the mattress torso section are at an orientation angle α of about 30° degrees but can be adjusted between a flat orientation (α=0°) and about 65°. The mattress occupies a volume of space above the framework referred to herein as a mattress region 58, i.e. the region of space that the mattress is intended to occupy.

The bed also includes a set of perimeter elements. These include a headboard 60 affixed to base frame 34. When the deck torso segment (and the mattress torso section) are at a flat orientation, the headboard is adjacent to the laterally extending edge of the mattress region at the head end of the bed. The perimeter elements also include a footboard 62 affixed to the elevatable frame so that the footboard is adjacent to the laterally extending edge of the mattress region at the foot end of the bed. Collectively the headboard and footboard are endboards. The perimeter elements also include left and right head end siderails 64, 66 and a left foot end siderail 68, all affixed to the elevatable frame so that each siderail is adjacent to the longitudinally extending left and right edges of the mattress region. Each siderail 64, 66, 68 can be placed in a raised position, as seen in the illustrations, in which it extends vertically above the top of the mattress region to partially define the perimeter of the mattress region. Each siderail 64, 66, 68 can also be placed in a lowered position to accommodate occupant ingress and egress.

As seen best in FIG. 5 base frame 34 includes a main frame portion 72 having a lateral dimension L_{B} and a secondary frame portion 74. As seen in FIG. 5 the secondary frame portion is separably connected to the main frame portion, for example by bolts 76. An alternative, seen in FIG. 1, is an integral construction such as a one piece main/secondary base frame or separately manufactured main and secondary frame portions secured together by a weld joint. Either way the secondary frame portion extends longitudinally past the mattress region and/or has a maximum lateral dimension L_{S} greater than the main frame lateral dimension L_{B}. The use of the term “secondary” is merely to distinguish the secondary frame portion from the primary frame portion, and not to diminish its status.

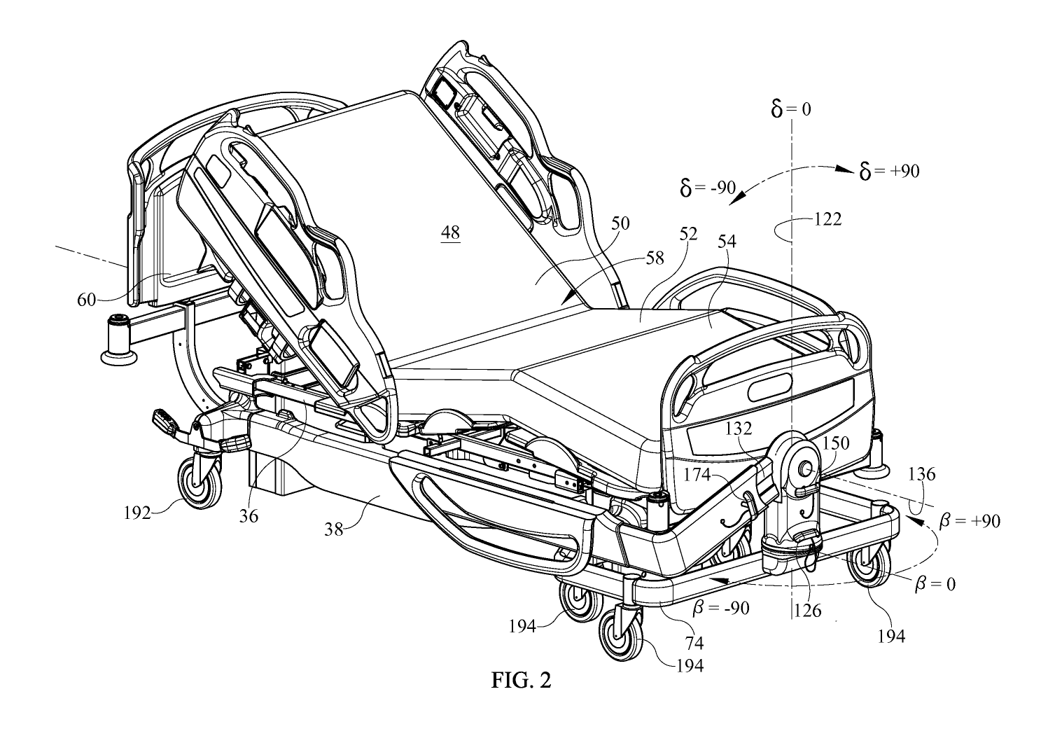

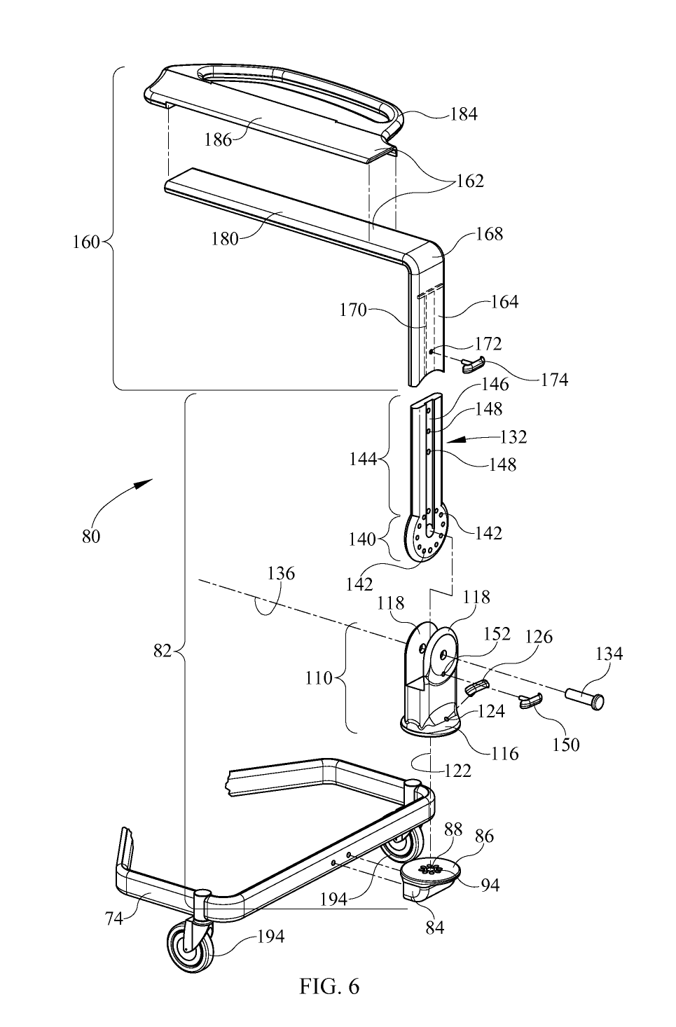

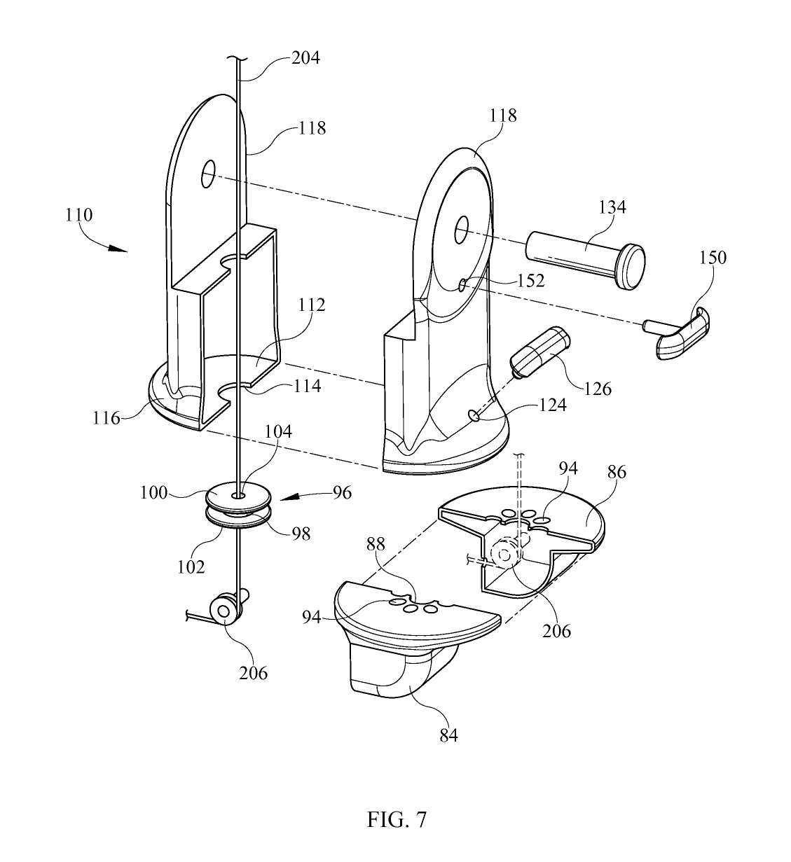

Referring additionally to FIGS. 6-7, the bed also includes a combination perimeter element/boom 80. The combination perimeter element/boom comprises a coupling 82 connected to or connectable to the base frame 38 specifically to the secondary frame portion 74 thereof. As seen in FIGS. 6-7 the coupling includes a hollow, cast aluminum mounting base 84 bolted to secondary frame portion 74 of base frame 34. Mounting base 84 includes a circular mounting pad 86 with a central opening 88 and a series of indexing holes 94. The coupling also includes a connector 96 comprising a cylinder 98 extending between top and bottom flanges 100, 102 and having a passage 104 extending therethrough. The bottom flange 102 is trapped inside the hollow interior of mounting base 84 so that cylinder 98 projects through opening 88. The'coupling also includes a hollow cast aluminum yoke 110 having a circular base 112 with a center opening 114, a foot 116, and a fork 118. When assembled, top flange 100 of connector 96 is trapped inside the hollow interior of the yoke so that yoke 110 is rotatably connected to mounting base 84 for rotation about a yaw axis 122. A yaw axis index hole 124 penetrates through the foot of the yoke. After a user rotates the yoke to a desired angular orientation β (FIGS. 1-2) corresponding to one of the yaw axis indexing holes 94, yaw axis locking pin 126 can be inserted through index hole 124 and into an indexing hole 94 to make the yoke nonrotational relative to mounting base 84.

Coupling 82 also includes a support arm 132 connected to yoke 110 by a clevis pin 134 so that the arm is rotatable relative to the yoke about a roll axis 136. A circular base portion 140 of the support arm includes roll axis indexing holes 142. An extension portion 144 of support arm 132 includes a slot 146 and a series of translation indexing holes 148. After a user rotates the support arm to a desired angular orientation δ (FIGS. 1-2) corresponding to one of the roll axis indexing holes 142, roll axis locking pin 150 can be inserted through index hole 152 in one prong of fork 118 and into an indexing hole 142 to make the arm nonrotational relative to the yoke.

The combination perimeter element/boom also includes a dual purpose unit 160 comprising a working element 162 and a hollow, working element connector sheath 164. An elbow 168 extends between the working element and the connector sheath. A rail 170 extends along the interior of the sheath. A translation index hole 172 penetrates through the sheath. The sheath fits over extension portion 144 of arm 132 with sheath rail 170 engaged in arm slot 146 to translatably connect working element 162 to support arm 132. A user can translate the sheath, and therefore the entire dual purpose unit, lengthwise along arm 132, i.e. radially relative to roll axis 136, to adjust the position of working element 162 relative to the roll axis. At any position where index hole 172 registers with one of the translation indexing holes 148, the user can insert translation locking pin 174 through index hole 172 and into the corresponding indexing hole 148 to secure the working element against further translation at a selected radial position relative to the roll axis.

As seen in FIGS. 1-4 the locking pins 126, 150, 174 may be tethered or otherwise connected to another part of the bed or the combination perimeter element/boom to guard against their loss or misplacement.

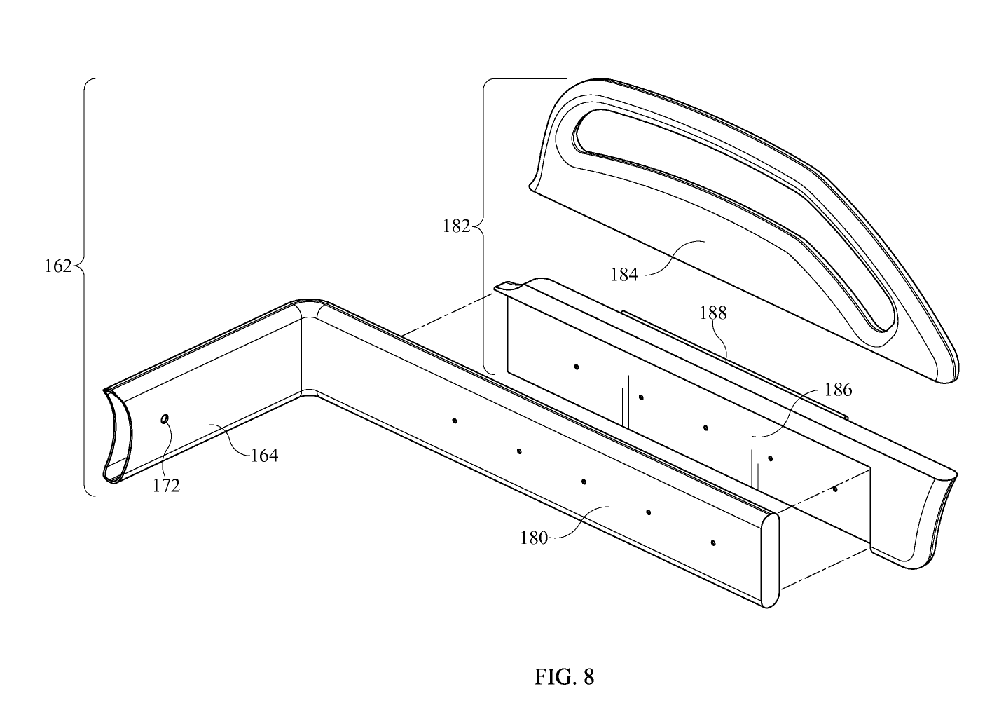

Referring to FIG. 8, working element 162 comprises an extruded aluminum load bearing portion 180 and a plastic blow molded auxiliary portion 182 attached to the load bearing extrusion by, for example, screws, rivets or epoxy. The auxiliary portion is comprised of an upper panel 184 connected to a lower panel 186 by a hinge 188.

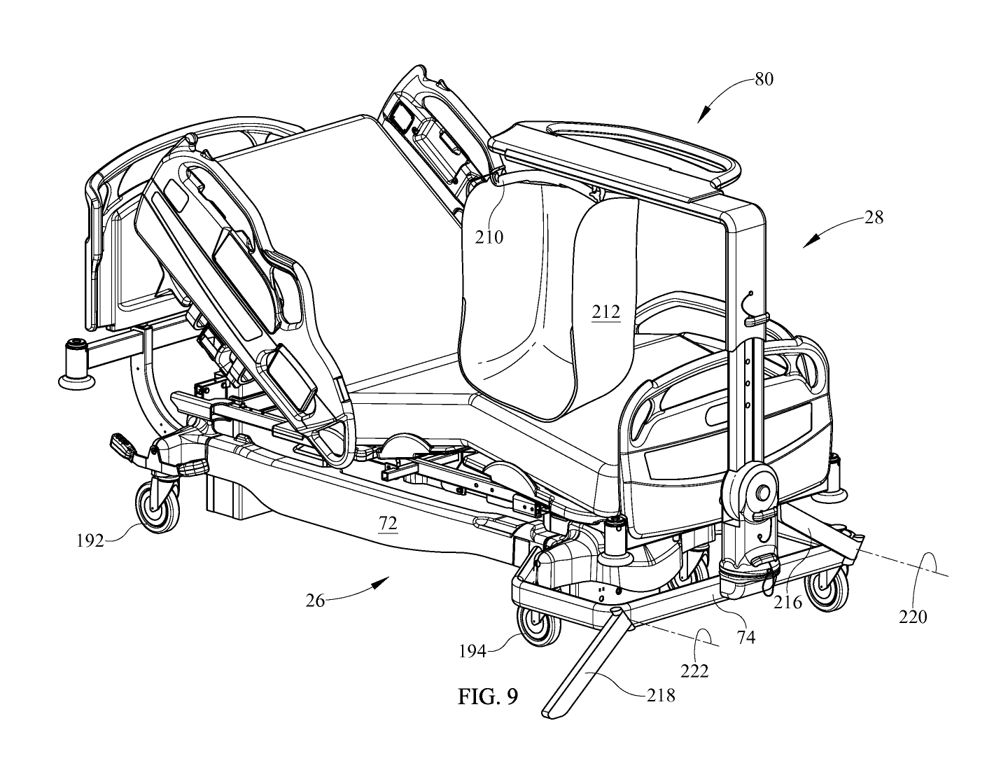

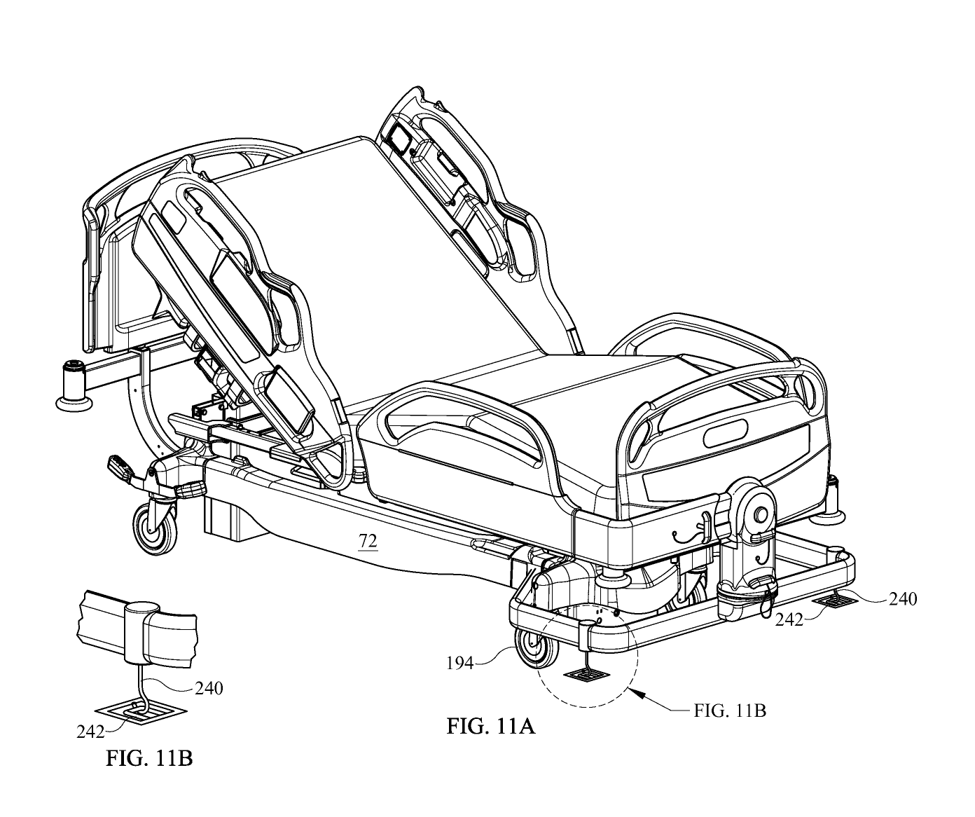

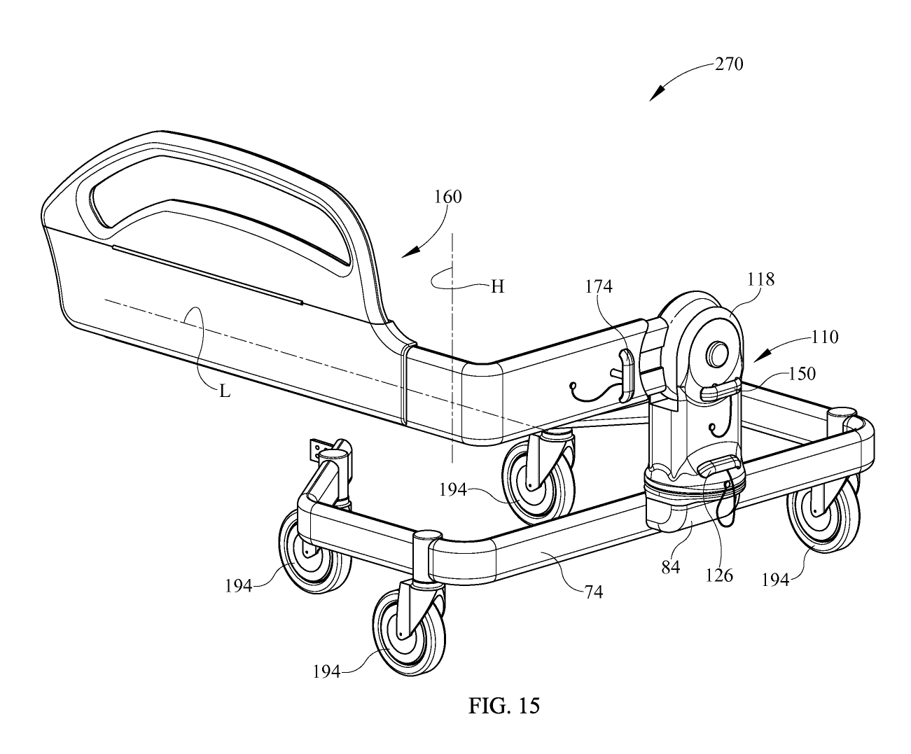

Referring principally to FIGS. 1-6, the bed also includes a pair of remote rollable supports such as casters 192 (only one of which is visible) extending from main frame portion 72 of base frame 34 at locations relatively remote from coupling 82 and at least two proximate rollable supports 194 extending from the frame at a location relatively more proximate to the coupling. In one embodiment the occupant support has exactly two remote rollable supports 192 and two or more proximate rollable supports 194. In a variant seen in FIGS. 9 and 11 the proximate rollable supports extend only from the main frame portion 72 of the base frame. In the variant of FIG. 15 the proximate rollable supports extend only from the secondary frame portion 74 of the base frame. In the variant of FIGS. 1-5 the proximate rollable supports extend from both the main frame portion and the secondary frame portion.

Referring to FIGS. 5 and 7 the occupant support also includes a hoist assembly comprising a hoist actuator, for example a winch 200 (FIG. 5) mounted on the base frame inside an actuator (winch) housing 202. Alternatively the actuator can be mounted on the combination perimeter element/boom. In the illustrated embodiment a winch cable 204 extends from the winch through secondary frame portion 74, and into hollow mounting base 84 where a cable guide 206 guides the cable through a 90° change of direction.

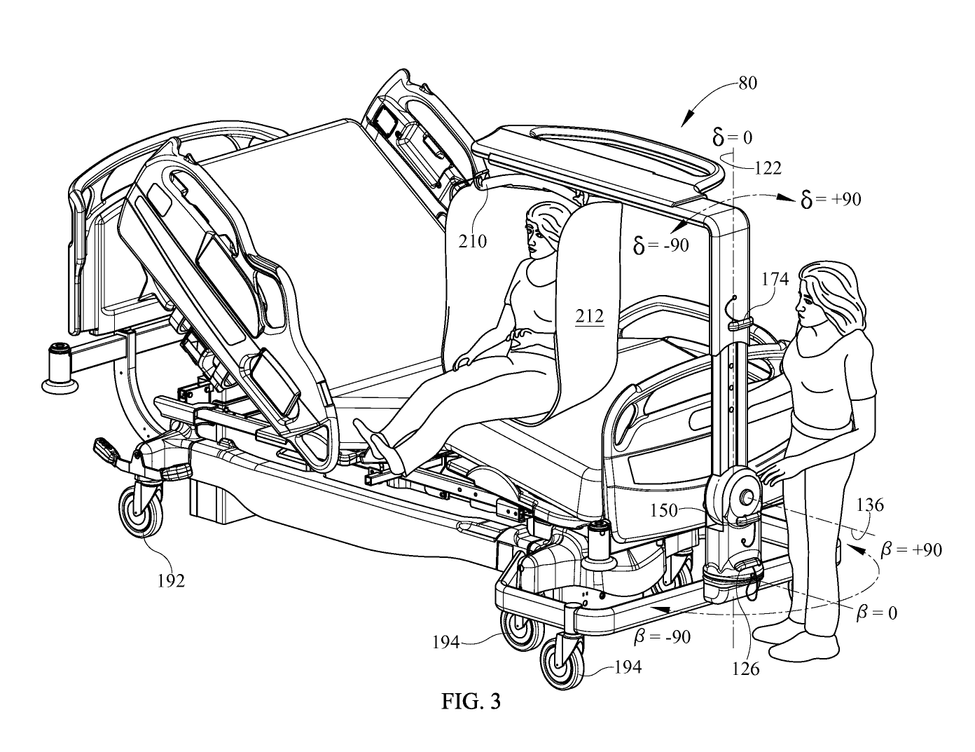

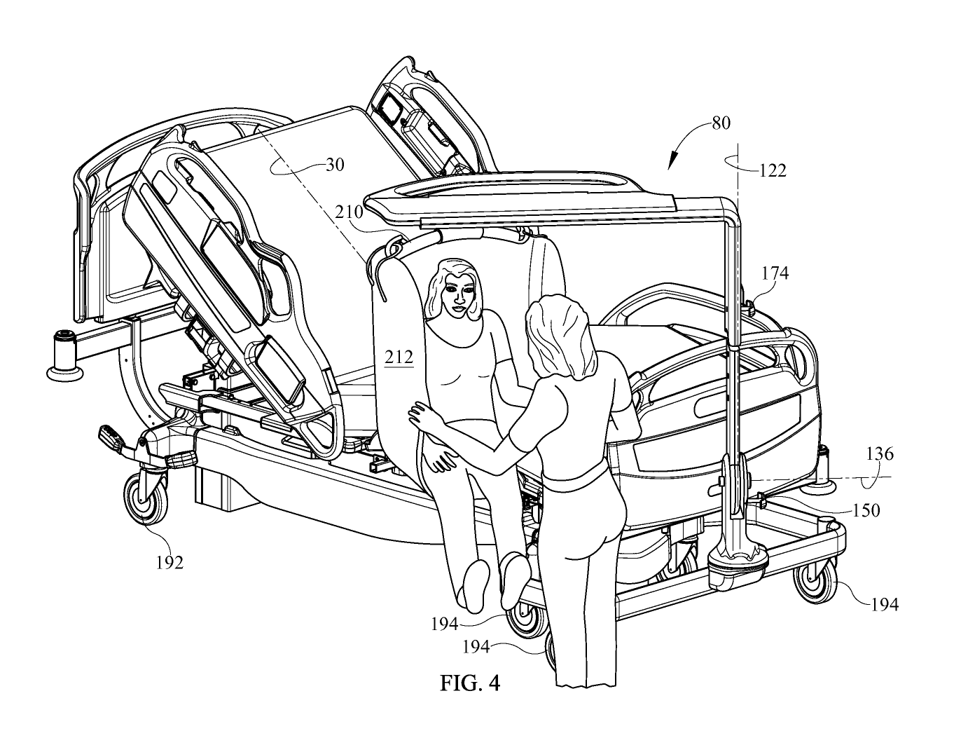

The cable then extends through passage 104 in connector 96 (FIG. 7), through yoke 110, arm 132, sheath 164, and into working element 162 of dual purpose unit 160. A free end of the cable exits from an opening (not visible) in the working element. The free end is coupled to a bar 210 (FIGS. 3-4). A patient support sling 212 is hooked onto the bar.

In operation, working element 162 is positionable in a perimeter element position (FIG. 1) in which the working element borders mattress region 58 and functions as a perimeter element. In the specific example shown in FIG. 1, yoke 110 is at an angular orientation β of 0°, arm 132 is at an angular orientation δ of −90°, and working element 162 is radially positioned relative to roll axis 136 so that the working element functions as the right side foot end siderail in a raised position. As seen in FIG. 2 support arm 132 can be rotated about roll axis to a “lower” orientation (e.g. about −120° as illustrated), thereby lowering the elevation of the rail to accommodate occupant ingress and egress. As also seen in FIG. 2 upper panel 184 has been rotated about hinge 188 to reduce the effective vertical dimension of the perimeter element to further facilitate ingress and egress.

As seen in FIG. 3 the working element is also positionable in a boom position, distinct from the perimeter element position, in which the working element is at an elevation higher than that of the mattress and can function as a weight bearing support boom. In comparison to FIG. 1, FIG. 3 shows arm 132 having been rotated to an angular orientation δ of 0° and working element 162 having been translated radially away from the roll axis 136 so that the entire working element is at an elevation higher than that of the mattress. An occupant is supported in sling 212. In practice, a caregiver would translate the working element radially away from the roll axis while the combination perimeter element/boom was in the position of FIG. 1. The caregiver would then rotate arm 132 about roll axis 136 to the position of FIG. 3, attach the bar 210 and sling 212 (if not, already attached) and, to the extent necessary, operate winch 200 to place the sling at an elevation low enough for the occupant to enter the sling. The caregiver would then operate the winch again to hoist the occupant off the mattress.

FIG. 4 also shows the working element in the boom position, but with yoke 110 having been rotated to an angular orientation β of about −45° so that the occupant is suspended over the floor rather than over the mattress. The caregiver can then operate the winch again to lower the occupant to, for example, the floor, a stretcher or a wheelchair.

With the basic construction and operation of the occupant support having now been described, certain additional features can be better appreciated.

In principle, the working element can be constructed entirely of a high strength material such as aluminum rather than of both aluminum and plastic. However the exclusive use of aluminum or other high strength material for the entire working element would be expensive and unnecessary.

In operation it may not be necessary to use the winch to elevate the bed occupant off the mattress. Instead, the bed lift mechanism can be used to lower the elevatable frame and mattress away from the sling.

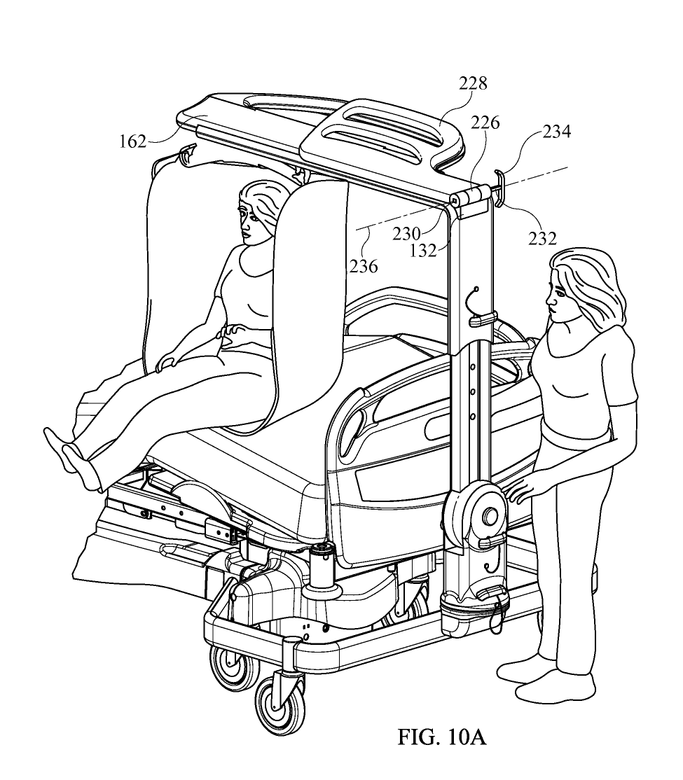

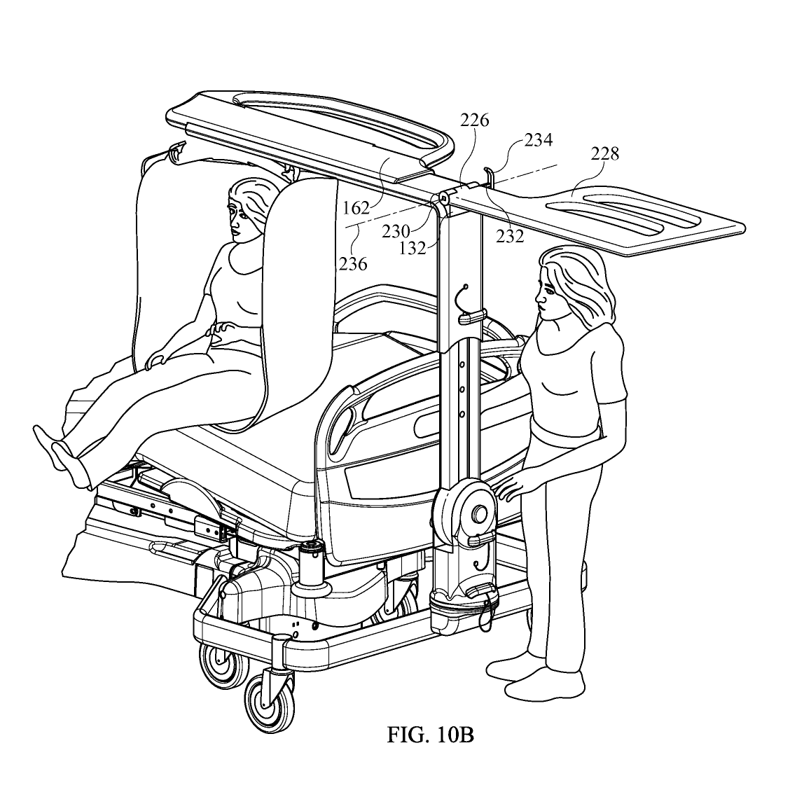

Referring to FIG. 5, the relatively large lateral dimension L_{S} of secondary frame portion 74 and the placement of casters 194 on the secondary frame as laterally far apart as possible help laterally stabilize the bed when the occupant is suspended a locations laterally offset from bed centerline 30 as in FIG. 4. Other lateral stabilizers include an outrigger, a counterweight and a tethering element. FIG. 9 shows left and right outriggers 216, 218. Each outrigger is rotatably affixed to the secondary frame portion 74 such that the outrigger is rotatable about an outrigger axis 220, 222. Each outrigger is rotatably moveable between a deployed state (left side outrigger 216) and a stored state (right side outrigger 218). In practice, both outriggers, not just one, would be deployed before rotating an occupant laterally away from centerline 30. FIGS. 10A and 10B show an arrangement in which a hinge 226 connects an extended length support arm 132 to a counterweight in the form of a counterweight panel 228. A square cross-section hole 230 extending through, the hinge receives a square shank 232 on a counterweight locking pin 234 to prevent the counterweight from pivoting about the hinge axis 236. In the stowed position the counterweight is folded against the working element 162 and locked in the folded state by locking pin 234. In the stowed position (FIG. 10A) the counterweight and, working element extend codirectionally away from the hinge. To deploy the counterweight a user removes the pin, rotates the counterweight panel 180° about hinge axis 236 to the deployed position (FIG. 10B) and reinserts the pin. In the deployed position the counterweight and working element extend counterdirectionally away from the hinge. Other hole 230 and pin 234 geometries (e.g. pentagonal, hexagonal) can be used to introduce some adjustability to the stabilizing effect of the deployed counterweight.

FIG. 11 shows a stabilizer in the form of a tethering element, such as a hook 240 secured to the bed. The hook engages a D-ring 242. If desired the D-ring may be spring loaded so that it projects above the floor when in use but snaps back flush with the floor when not in use.

The combination perimeter element/boom described herein is exemplified as a combination siderail/boom, specifically a foot end siderail/boom. However a combination perimeter element/boom in the form of a head end siderail/boom, a headboard/boom or a footboard/boom is also contemplated.

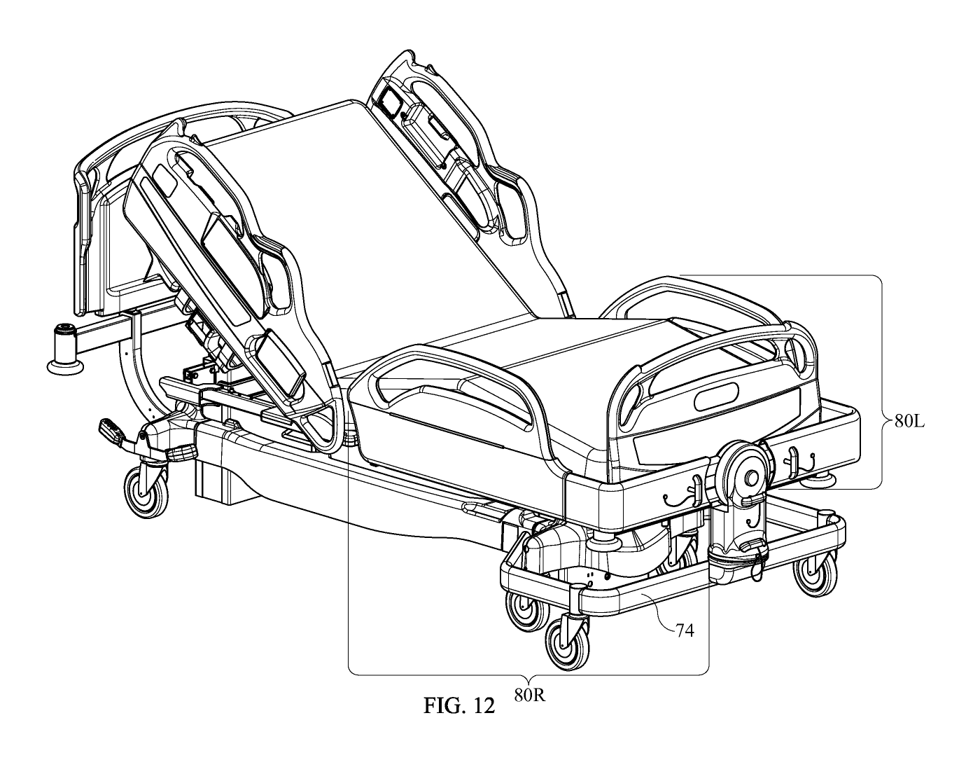

FIG. 12 shows an occupant support similar to the one already described, but with a dual perimeter element/boom featuring a left side perimeter element/boom 80L and right side perimeter element/boom 80R.

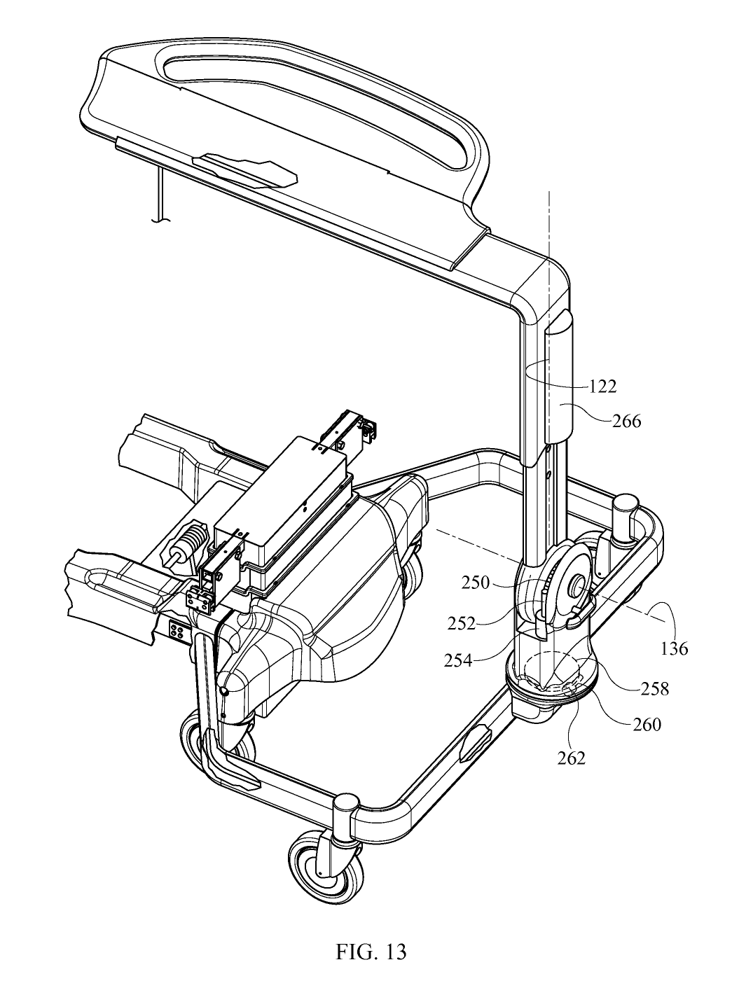

FIG. 13 shows a fully powered variant of the occupant support. The occupant support of FIG. 13 includes a roll actuator for effecting rotation about roll axis 136, a yaw actuator for effecting rotation about yaw axis 122, or both. In the illustrated embodiment the roll actuator comprises a roll gear 250 affixed to or formed on the base portion 140 of support arm 132 and a roll worm 252 engaged with the roll gear and powered by roll motor 254. The yaw actuator comprises a yaw gear 258 affixed to yoke 110 and a yaw worm 260 engaged with the yaw gear and powered by a yaw motor 262. The illustrated embodiment’ also includes a translation actuator 266 such as a leadscrew mechanism for effecting translation of the working element.

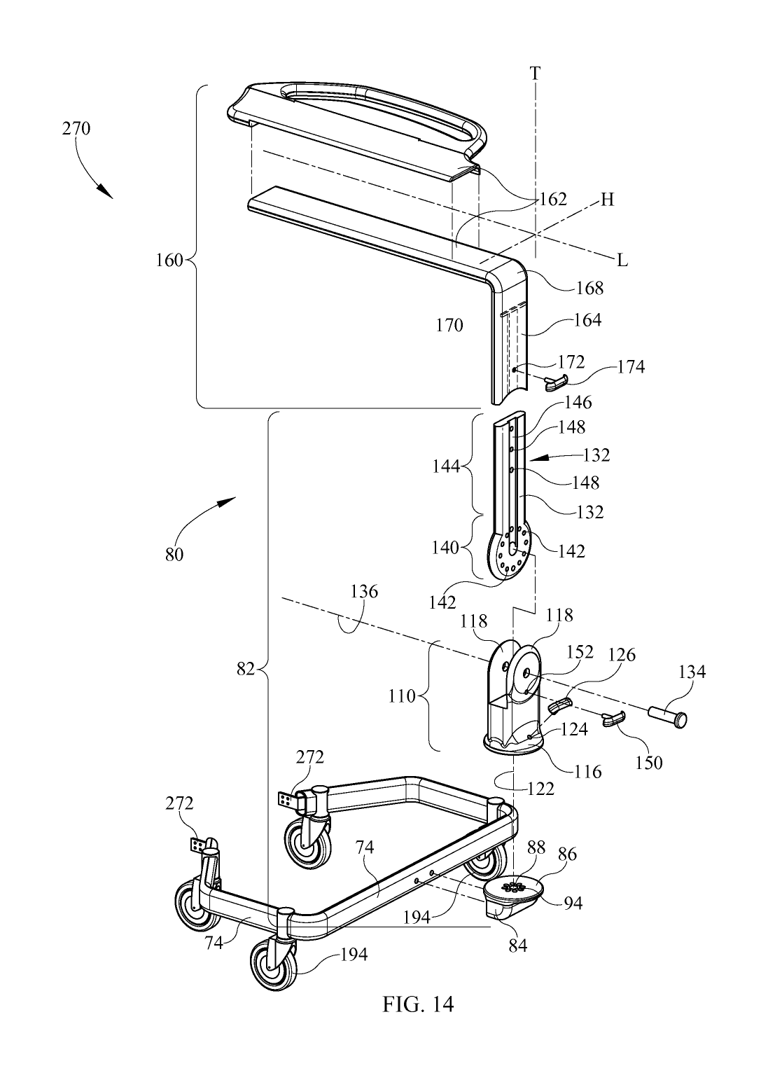

Although the combination perimeter element/boom has been illustrated and described as a component of a bed, it can, with little or no change, be a module intended to be nonpermanently mated to a bed, most likely for a limited period of time. Referring to FIGS. 14-15, a combination perimeter element/boom module 270 comprises a frame 74 analogous to the secondary frame portion 74 of the occupant support already described. The frame includes a set of flanges 272 for attaching the module to a bed frame, e.g. by bolts. A coupling 82 is connected to or connectable to the frame and to a working element 162 having mutually orthogonal length, height and width or thickness axes L, H, T. As with the component perimeter element/boom already described, the coupling renders the working element positionable in a perimeter element position (FIG. 15) in which the length and height axes lie in a vertical plane or a near vertical plane and in a boom position, distinct from the perimeter element position, in which the length and height axes lie in a horizontal plane (FIG. 14). In the modular embodiment it may be advantageous to mount winch 200 on the modular unit itself rather than on the bed frame.

The illustrated modular unit includes four rollable elements (e.g. casters) 94 rather than the two rollable elements shown on the secondary frame portion of the component unit (e.g. FIG. 15) to facilitate transport of the module from bed to bed as needed. However the use of only two rollable elements is not precluded and may be attractive if the modular unit is a retrofit product intended to be attached to a bed and left in place indefinitely.

In all other respects the modular unit is the same as the component unit already described in the context of an occupant support.

Although this disclosure refers to specific embodiments, it will be understood by those skilled in the art that various changes in form and detail may be made without departing from the subject matter set forth in the accompanying claims.

I claim:

1. An occupant support comprising:
a frame;
a mattress region; and
a combination perimeter element/boom, the combination comprising a coupling connected or connectable to the frame and to a working element, the coupling configured to render the working element positionable in a perimeter element position in which the working element borders the mattress region and functions as a perimeter element and a boom position in which the working element is at an elevation higher than that of the mattress and can function as a boom.

2. The occupant support of claim 1 wherein the frame includes a main frame portion and a secondary frame portion integral with the main frame portion, the combination being connected or connectable to the secondary frame portion.

3. The occupant support of claim 1 wherein the frame includes a main frame portion and a secondary frame portion separable from the main frame portion, the combination being connected or connectable to the separable secondary frame portion.

4. The occupant support of claim 2 wherein the main frame portion has a lateral dimension and the secondary frame portion extends longitudinally past the mattress region and/or has a maximum lateral dimension greater than the main frame lateral dimension.

5. The occupant support of claim 3 wherein the main frame portion has a lateral dimension and the secondary frame portion extends longitudinally past the mattress region and/or has a maximum lateral dimension greater than the main frame lateral dimension.

6. The occupant support of claim 2 including remote rollable supports extending from the frame at a location remote from the coupling and proximate rollable supports extending from the frame at a location more proximate to the coupling.

7. The occupant support of claim 3 including remote rollable supports extending from the frame at a location remote from the coupling and proximate rollable supports extending from the frame at a location more proximate to the coupling.

8. The occupant support of claim 6 comprising exactly two remote rollable supports and two or more proximate rollable supports.

9. The occupant support of claim 8 wherein the two or more proximate rollable supports are selected from the group consisting of 1) rollable supports extending only from the main frame portion, 2) rollable supports extending only from the secondary frame portion, and 3) rollable supports extending both the main frame portion and the secondary frame portion.

10. The occupant support of claim 1 wherein the coupling is rotatable about a roll axis and about a yaw axis.

11. The occupant support of claim 10 wherein the working element is radially adjustable relative to the roll axis.

12. The occupant support of claim 11 wherein the working element can be locked at a selected radial position relative to the roll axis.

13. The occupant support of claim 10 wherein the combination perimeter element/boom is a combination siderail/boom in which the working element is positionable as and functions as a siderail and is also positionable in the boom position.

14. The occupant support of claim 10 including at least one of a roll actuator for effecting rotation about the roll axis and a yaw actuator for effecting rotation about the yaw axis.

15. The occupant support of claim 14 wherein the roll actuator, if present, comprises a roll gear affixed to the support arm and a powered worm engaged with the roll gear and wherein the yaw actuator, if present, comprises a yaw gear affixed to the yoke and a powered worm engaged with the yaw gear.

16. The occupant support of claim 14 including at least one translation actuator for effecting translation of the working element.

17. The occupant support of claim 15 including at least one translation actuator for effecting translation of the working element.

18. The occupant support of claim 1 wherein the working element comprises a load bearing portion and an auxiliary portion.

19. The occupant support of claim 1 wherein the coupling comprises a mounting base, a yoke rotatably connected to the mounting base, and a support arm rotatably connected to the yoke, the working element being connected to the support arm.

20. The occupant support of claim 19 wherein the yoke can be made nonrotational at two or more yoke angular orientations and the support arm can be made nonrotational at two or more support arm angular orientations.

21. The occupant support of claim 19 wherein the working element is translatably coupled to the support arm.

22. The occupant support of claim 21 wherein the working element can be secured against translation at two or more positions.

23. The occupant support of claim 1 wherein the working element is translatable relative to the coupling.

24. The occupant support of claim 23 wherein the working element can be made secured at a selected position.

25. The occupant support of claim 1 including a hoisting actuator mounted on one or the other of the frame and the combination perimeter element/boom.

26. The occupant support of claim 25 in which the hoisting actuator is a winch and in which a cable extends from the winch to the combination perimeter element/boom.

27. The occupant support of claim 1 including a lateral stabilizer.

28. The occupant support of claim 27 wherein the lateral stabilizer is selected from the group consisting of an outrigger, a counterweight, and a tethering element.

29. The occupant support of claim 28 wherein the outrigger, if present, is affixed to the frame and is moveable between a deployed state and a stored state and the counterweight, if present, is affixed to a support arm that extends from the coupling and is moveable between a deployed state and a stored state.

30. The occupant support of claim 28 wherein the working element extends in a first direction relative to the support arm and the counterweight extends codirectionally with the working element when the counterweight is stored and extends counterdirectionally to the working element when the counterweight is deployed.

31-52. (canceled)
